(19) United States
(12) Patent Application Publication
(10) Pub. No.: US 2010/0160475 A1
(43) Pub. Date: Jun. 24, 2010

(54) Method for tack free surface photocuring of free radically polymerizable resins under visible light photoexcitation

(76) Inventors: Eugene Stizmann, Newark, DE (US); Ionel Spinu, Hockessin, DE (US); Andre Bendo, Aston, PA (US)

Correspondence Address: BASF Performance Products LLC;Patent Department, 540 White Plains Road, P.O. Box 2005, Tarrytown, NY, 10591, US

(21) Appl. No.: 12/455,915

(22) Filed: Jun. 9, 2009

Related U.S. Application Data
(60) Provisional application No. 61/131,652, filed on Jun. 11, 2008.

(51) Int. Cl. C08F 2/50

(52) U.S. Cl. 522/46; 522/64

(57) ABSTRACT

Disclosed is a method for photocuring certain thin layer ethylenically unsaturated systems using an additive composition comprising a photoinitiator and an acrylated siloxane and irradiating the layer at wavelengths above 350 nm. For example, the additive composition comprises at least one bisacylphosphine oxide or monoacylphosphine oxide and at least one acrylated siloxane and can be cured using visible light sources such as a light emitting diode (LED). The process provides for tack free films 10 mils (=0.254 mm) thick or less.

This application claims benefit under 35 USC 119(e) of U.S. provisional application No. 61/131,652, filed Jun. 11, 2008, incorporated herein in its entirety by reference.

A method for photocuring thin sections to produce tack free thin films by incorporating a combination of at least one photoinitiator which is active at long wavelength UV or visible light, such as a monoacyl phosphine oxide or bisacyl phosphine oxide, and a reactable siloxane derivative, such as an acrylated siloxane, into a film forming composition containing an ethylenically unsaturated species, such as an unsaturated polyester resin or acrylate monomer, and optionally binder polymers and other components, and then exposing the formulation to light, is provided by the present invention. Low energy light, such as visible light or long wavelength UV light, i.e., light with wavelengths above 390 nm, is conveniently used at low intensities. The method of the invention can be used to produce tack free, thin film coatings on a variety of substrates.

US 2005/234145-A, incorporated herein in its entirety by reference, discloses a process for photocuring certain thick layer ethylenically unsaturated systems with a light emitting diode (LED) light source using acylphosphine oxide photoinitiators. The process of US 2005/234145-A is useful in the production of, for example, acrylate based thick coatings, thick gel coats, thick multi-ply composites or thick adhesive layers. Thick coatings are greater than about 10 mils (i.e., about 0.25 mm), for example from greater than 10 mils to about 30 mils (about 0.76 mm).

However, the photocuring of thin sections, e.g. films or coatings of less than about 10 mil (about 0.25 mm), remains problematic. Oxygen inhibition, whereby oxygen present in the atmosphere quenches the reactive species produced by photoexcitation at the surface of a coating, is a recognized problem in creating tack free surfaces. A thin coating can be thought of as largely surface which can exaggerate the effect of oxygen inhibition.

The process of US 2005/234145-A is not entirely satisfactory for thin section curing, because in this limit one finds excessive surface tack that is not desired. The mono- and bisacylphosphine oxides used therein are noted for excellent through-cure capability, but have limited or poor surface curing capability. Indeed, gel coats are formulated to use bisacylphosphine oxides (BAPO) as the preferred photoinitiator mainly because of the need to have good through-cure but with a tacky surface (or incomplete surface cure), allowing the gel coat to bond to the laminate.

Also, at present, visible light or long wavelength UV light, such as that produced by LED array equipment (395 nm) is not used for thin section curing (2-10 mil thickness [0.05-0.25 mm]) of standard UV curable coating formulations unless it is accompanied by an oxygen purged atmosphere. The oxygen purge is necessary to eliminate the inhibition effects seen under low light flux and thin section curing conditions.

The present invention provides a method for photocuring thin films, for example films less than 10 mil (0.25 mm) thick, or films less than 0.20 mm, or 0.15 mm thick. The additive composition, for example, monoacyl phosphine oxide and/or bisacyl phosphine oxide and an acrylated siloxane, permit rapid and complete curing using LED or other visible light sources. This capability thus eliminates the costly use of oxygen purging and is more effective than other methods presently practiced in the in the art such as the use of benzophenone and/or amines. The additive compositions are easily incorporated into a variety of photocurable systems and provide excellent durability, good surface characteristics (high solvent resistance, high gloss, high hardness and smoothness) and excellent adhesion to the substrate. This invention is particularly useful, for example, in curing inks, coatings and adhesives using visible light curing equipment by overcoming surface tack under low light intensity visible light exposure.

While a wide variety of light sources can be used in the practice of the invention, excellent results are achieved using low intensity sources of light with wavelengths of 390 nm or higher, e.g., visible light, which offers both energy savings and prevents possible damage to the film or substrate caused by high energy UV light. For example, the present method is very effective in curing film forming formulations comprising unsaturated polyesters using an LED array with a near visible/visible emission centered at approximately 395 nm or the visible light from a fluorescent bulb.

### DESCRIPTION OF THE INVENTION

The invention provides a process for curing formulations comprising ethylenically unsaturated polymerizable compounds, such as unsaturated polyester monomers, oligomers and polymers, to prepare tack free thin films of from about 0.1 mil to about 10 mil (i.e., 0.002 mm to 0.25 mm), which process comprises
1) preparing a composition comprising
   a) said ethylenically unsaturated polymerizable compounds,
   b) from about 0.1 weight percent to about 4 weight percent based on the weight of the cured film solids of at least one photoinitiator, for example, at least one acyl phosphine oxide photoinitiator and
   c) from about 0.5 weight percent to about 3 weight percent based on the weight of the cured film solids of at least one acrylated siloxane, for example a monofunctional acry late siloxane, and
2) irradiating the mixture so obtained with light comprising wavelengths of from about 350 nm to about 600 nm, for example, from about 375 nm to about 500 nm, for example, from about 390 nm to about 450 nm, for example, visible light from a fluorescent bulb or the radiation from a light emitting diode source.

The film obtained according to the process of the present invention has a thickness (after curing) of from about 0.1 mil (0.002 mm) to about 10 mil (0.25 mm), for example from about 0.5 mil (0.013 mm) to about 10 mil (0.25 mm), for example from about 1 mil (0.025 mm) to about 5 mil (0.13 mm); or for example from 0.002 mm to 0.20 mm, for example from 0.002 mm to 0.15 mm, for example from 0.013 mm to 0.20 mm, or 0.013 mm to 0.15 mm.

The photoinitiator (b) of the above composition is a photoinitiator which is active at wavelengths of light greater than about 350 nm, for example the photoinitiator is active at wavelengths of light greater than about 390 nm, for example the photoinitiator is active at wavelengths of visible light. Such photoinitiators include mono acylphosphine oxides and bisacylphosphine oxides, red-shifted phenylglyoxylates, red shifted benzophenones, isoproylthioxanthones and alpha amino ketones.

Advantageously, the composition includes at least one monoacylphosphine oxide photoinitiator or at least one bisacylphosphine photoinitiator. Mixtures of monoacylphosphine oxide and bisacylphosphine oxide photoinitiators are also advantageously employed as photoinitiator (b). More than one monoacylphosphine oxide photoinitiator or one bisacylphosphine photoinitiator may be used.

Also advantageously, mixtures of either monacylphosphine oxide or bisacylphosphine oxide photoinitiators with α-hydroxyketone photoinitiators are employed as photoinitiator (b).

Likewise, mixtures of monoacylphosphine oxide, bisacylphosphine oxide and α-hydroxyketone photoinitiators are employed as photoinitiator (b). For example, the photoinitiator (b) is a mixture of photoinitiators comprising at least one mono-acylphosphine oxide and/or at least one bis-acylphosphine oxide photoinitiator and at least one α-hydroxyketone photoinitiator.

Acrylated siloxanes (c) of the invention are, for example, known commercial products frequently employed as slip agents or leveling agents. Mono functional and poly functional acrylated siloxanes are known and can be used. For example, the commercially available material EFKA® 3883 is a monofunctional acrylate siloxane which is useful in the process of the present invention. Other commercial products, e.g. other slip agents or leveling agents provided can also be used.

Monoacylphosphine oxide photoinitiators and bisacylphosphine photoinitiators are also commercially available. Mixtures of monoacylphosphine oxide photoinitiators and bisacylphosphine photoinitiators are commercially available as are mixtures of mono- or bisacylphosphine oxides and compounds of other classes of photoinitiators.

The preparation of monoacylphosphine oxide photoinitiators and bisacylphosphine photoinitiators is known to the person skilled in the art and for example disclosed in U.S. Pat. No. 4,298,738 or WO 00/32612.

The “additive package” or “additive composition” of the instant invention is the combination of the at least one photoinitiator (b) and the at least one acrylated siloxane (c). For example, the additive composition may consist of (acylphosphine oxide) photoinitiators (b) and (reactable) acrylated siloxanes (c) in ratios of about 1:9 to ratios of about 9:1. For example, the photoinitiator (b) comprises (i) a mono-acylphosphine oxide or (ii) a bis-acylphosphine oxide or (iii) a mixture of photoinitiators containing at least one mono-acylphosphine oxide or bisacylphosphine oxide, and the at least one acrylated siloxane (c) is a mono-acyrlated siloxane, and the ratio of the photoinitiator (b) and the acrylated siloxane (c) is of from 3:1 to 1:1.

The term “acylphosphine oxide photoinitiator” in the context of the present invention stands for both, monoacylphosphine oxide photoinitiator and bisacylphosphine oxide photoinitiator.

Examples of additive compositions made up of commercially available materials include 3 parts IRGACURE® 2100 as photoinitiator and 1 part EFKA® 3883 as acrylated siloxane, 2 parts IRGACURE® 819 and 1 part EFKA® 3883.

The IRGACURE® 2100 and/or IRGACURE® 819 are photobleachable acylphosphine oxide photoinitiators containing visible light active photoinitiators. (IRGACURE AND EFKA are tradenames of Ciba Inc.)

Acylphosphine oxide photoinitiators are disclosed for example in U.S. Pat. No. 4,324,744, U.S. Pat. No. 4,737,593, U.S. Pat. No. 5,942,290, U.S. Pat. No. 5,534,559, U.S. Pat. No. 6,020,528, U.S. Pat. No. 6,486,228 and U.S. Pat. No. 6,486,226, the relevant disclosures of which are hereby incorporated by reference.

The bisacylphosphine oxide photoinitiators are of the formula I

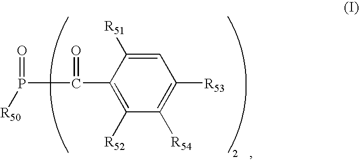

wherein

R₅₀ is C₁-C₁₂alkyl, cyclohexyl or phenyl which is unsubstituted or is substituted by 1 to 4 halogen, C₁-C₈alkyl, SR₁₀ or N(R₁₁)(R₁₂);

R₁₀, R₁₁ and R₁₂ are each independently of the others hydrogen, C₁-C₂₄alkyl, C₂-C₂₄alkenyl, C₃-C₈cycloalkyl, phenyl, benzyl, or C₂-C₂₀alkyl which is interrupted one or more times by nonconsecutive O atoms and which is unsubstituted or substituted by OH and/or SH; or

R₁₁ and R₁₂ together with the N atom to which they are bonded form a 5- or 6-membered ring, which may also contain O or S atoms or NR₁₃;

R₁₃ is hydrogen, phenyl, C₁-C₁₂alkoxy, C₁-C₁₂alkyl, or C₂-C₁₂alkyl which is interrupted one or more times by O or S and which is unsubstituted or substituted by OH and/or SH;

R₅₁ and R₅₂ are each independently of the other C₁-C₈ alkyl or C₁-C₈alkoxy;

R₅₃ is hydrogen or C₁-C₈ alkyl; and

R₅₄ is hydrogen or methyl.

For example, R₅₀ is C₂-C₁₀alkyl, cyclohexyl or phenyl which is unsubstituted or is substituted by 1 to 4 C₁-C₄alkyl, Cl or Br.

In another embodiment R₅₀ is C₃-C₈alkyl, cyclohexyl or phenyl which is unsubstituted or is substituted in the 2-, 3-, 4- or 2,5-positions by C₁-C₄alkyl. For example, R₅₀ is C₄-C₁₂alkyl or cyclohexyl, R₅₁ and R₅₂ are each independently of the other C₁-C₈alkyl or C₁-C₈alkoxy and R₅₃ is hydrogen or C₁-C₈alkyl. For example, R₅₁ and R₅₂ are C₁-C₄alkyl or C₁-C₄alkoxy and R₅₃ is hydrogen or C₁-C₄ alkyl.

In another embodiment is where R₅₁ and R₅₂ are methyl or methoxy and R₅₃ is hydrogen or methyl. For example R₅₁, R₅₂ and R₅₃ are methyl. In one embodiment R₅₁, R₅₂ and R₅₃ are methyl and R₅₄ is hydrogen.

In a particular embodiment R₅₀ is C₃-C₈alkyl. For example R₅₀ is isobutyl or phenyl. For example, R₅₁ and R₅₂ are methoxy, R₅₃ and R₅₄ are hydrogen and R₅₀ is isooctyl.

The present bisacylphosphine oxide photoinitiator is for example bis(2,4,6-trimethylbenzoyl)-phenylphosphine oxide (CAS #162881-26-7) or is bis(2,4,6-trimethylbenzoyl)-(2,4-bis-pentyloxyphenyl)phosphine oxide.

The monoacylphoshine oxide photoinitiators are of the formula II

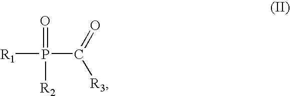

wherein

R₁ and R₂ independently of one another are C₁-C₁₂alkyl, benzyl, phenyl which is unsubstituted or substituted from one to four times by halogen, C₁-C₈alkyl and/or C₁-C₈alkoxy, or are cyclohexyl, or R₁ is —OR₄;

R₃ is phenyl which is unsubstituted or substituted from one to four times by C₁-C₈alkyl, C₁-C₈alkoxy, C₁-C₈alkylthio and/or halogen; and

R₄ is C₁-C₈alkyl, phenyl or benzyl.

For example, R₁ is —OR₄ or phenyl.

For example R₂ is phenyl which is unsubstituted or substituted from one to four times by halogen, C₁-C₈alkyl and/or C₁-C₈alkoxy.

For example R₃ is phenyl which is unsubstituted or substituted from one to four times by C₁-C₈alkyl.

For example R₁ and R₂ both are phenyl.

For example, the present monoacylphosphine oxide is 2,4,6-trimethylbenzoylethoxyphenylphosphine oxide (CAS #84434-11-7) or 2,4,6-trimethylbenzoyldiphenylphosphine oxide (CAS #127090-72-6).

The present process may employ further photoinitiators as component (d), for example α-hydroxy ketone photoinitiators of the formula III

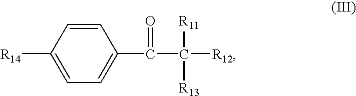

wherein

R₁₁ and R₁₂ independently of one another are hydrogen, C₁-C₆alkyl, phenyl, C₁-C₆alkoxy, OSiR₁₆(R₁₇)₂ or —O(CH₂CH₂O)_{q}-C₁-C₆alkyl, or

R₁₁ and R₁₂, together with the carbon atom to which they are attached, form a cyclohexyl ring;

q is a number from 1 to 20;

R₁₃ is OH;

R₁₄ is hydrogen, C₁-C₁₈alkyl, C₁-C₁₂hydroxyalkyl, C₁-C₁₈alkoxy, —OCH₂CH₂—OR₁₅, —CH═CH₂, —C(CH₃)═CH₂ or is

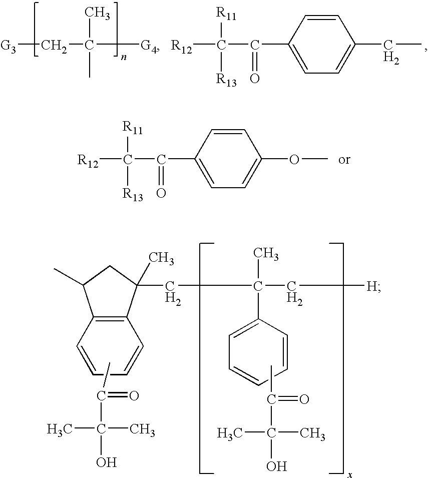

x is 0 or 1;

n is a number from 2 to 10;

R₁₅ is hydrogen, —COCH═CH₂ or —COC(CH₃)═CH₂;

R₁₆ and R₁₇ independently of one another are C₁-C₈alkyl or phenyl; and

G₃ and G₄ independently of one another are end groups of the polymeric structure, preferably hydrogen or methyl.

α-Hydroxy ketone photoinitiators that are of interest are those in which R₁₁ and R₁₂ independently of one another are hydrogen, C₁-C₆alkyl or phenyl or R₁₁ and R₁₂, together with the carbon atom to which they are attached, form a cyclohexyl ring, R₁₃ is OH, and R₁₄ is hydrogen, C₁-C₁₂alkyl, C₁-C₁₂alkoxy, —OCH₂CH₂OR₁₅, —C(CH₃)═CH₂ or is

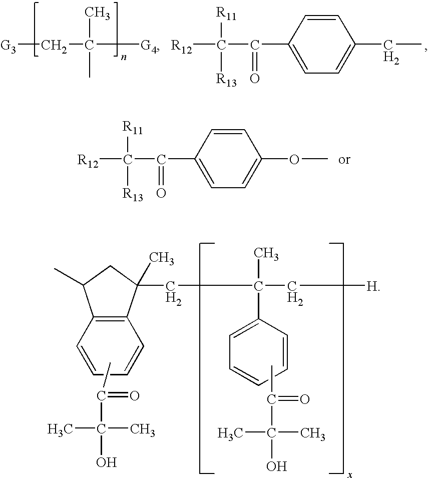

For example, suitable as the α-hydroxy ketone photoinitiators are those in which R₁₁ and R₁₂ independently of one another are methyl or ethyl or R₁₁ and R₁₂, together with the carbon atom to which they are attached, form a cyclohexyl ring, R₁₃ is OH and R₁₄ is hydrogen, C₁-C₄alkyl, C₁-C₄alkoxy or —OCH₂CH₂OH.

Interesting also are compounds, wherein R₁₄ is

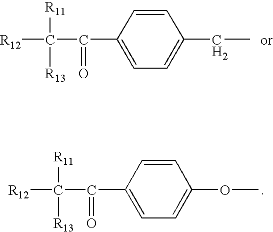

Further of interest are oligomeric α-hydroxy ketone photoinitiators of the formula I, wherein

R₁₄ is

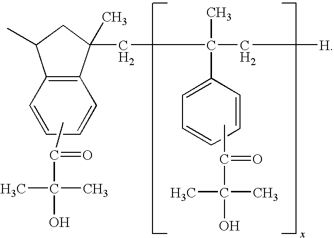

For example, suitable α-hydroxy ketone photoinitiators are

α-hydroxycyclohexyl phenyl ketone,

2-hydroxy-2-methyl-1-phenylpropanone,

2-hydroxy-2-methyl-1-(4-isopropylphenyl)propanone,

2-hydroxy-2-methyl-1-(4-dodecylphenyl)propanone,

2-hydroxy-1-{4-[4-(2-hydroxy-2-methyl-propionyl)-benzyl]-phenyl}-2-methyl-propan-1-one and

2-hydroxy-2-methyl-1-[(2-hydroxyethoxy)phenyl]propanone.

The present α-hydroxy ketone photoinitiator is for example α-hydroxycyclohexylphenyl ketone or 2-hydroxy-2-methyl-1-phenyl-1-propanone.

Straight or branched chain alkyl is for example, methyl, ethyl, propyl, isopropyl, butyl, isobutyl, sec-butyl, tert-butyl, pentyl, isopentyl, isooctyl, hexyl, heptyl, octyl, nonyl, decyl or dodecyl. Likewise alkoxy or alkylthio are of the same straight or branched chains.

Suitable photoinitiator blends (PI blends) are for example disclosed in U.S. Pat. No. 6,020,528 and U.S. Application No. 60/498,848, the disclosure of which patent and application are hereby incorporated by reference.

The present PI (photoinitiator) blends are for example a mixture of bis(2,4,6-trimethylbenzoyl)phenylphosphine oxide (CAS #162881-26-7) and 2,4,6,-trimethylbenzoylethoxyphenyl-phosphine oxide (CAS #84434-11-7) in weight:weight ratios of about 1:11, 1:10, 1:9, 1:8 or 1:7.

Another especially suitable PI blend is a mixture of bis(2,4,6-trimethylbenzoyl)phenylphosphine oxide, 2,4,6,-trimethylbenzoylethoxyphenylphosphine oxide and 2-hydroxy-2-methyl-1-phenyl-1-propanone (CAS #7473-98-5) in weight ratios of for instance about 3:1:15 or 3:1:16 or 4:1:15 or 4:1:16.

Another suitable PI blend is a mixture of bis(2,4,6-trimethylbenzoyl)phenylphosphine oxide and 2-hydroxy-2-methyl-1-phenyl-1-propanone in weight ratios of for instance about 1:3, 1:4 or 1:5.

Other suitable photoinitiators (b) or (d) according to this invention are for example, other mono- or bisacylphosphine oxides such as diphenyl-2,4,6-trimethylbenzoylphosphine oxide or bis(2,6-dimethoxybenzoyl)-2,4,4-trimethylpentylphosphine oxide; α-hydroxyketones, such as 1-hydroxycyclohexylphenylketone or 2-hydroxy-1-[4-(2-hydroxyethoxy)phenyl]-2-methyl-1-propanone; α-aminoketones, such as 2-methyl-1-[4-(methylthio)phenyl]-2-(4-morpholinyl)-1-propanone, 2-benzyl-2-(dimethylamino)-1-[4-(4-morpholinyl)phenyl]-1-butanone, 2-(4-methyl-benzyl-2-(dimethylamino)-1-[4-(4-morpholinyl)phenyl]-1-butanone or 2-benzyl-2-(dimethylamino)-1-[3,4-dimethoxyphenyl]-1-butanone; benzophenones, such as benzophenone, 2,4,6-trimethylbenzophenone, 4-methylbenzophenone, 2-methylbenzophenone, 2-methoxycarbonylbenzophenone, 4,4′-bis(chloromethyl)benzophenone, 4-chlorobenzophenone, 4-phenyl-benzophenone, 4,4′-bis(dimethylamino)benzophenone, 4,4′-bis(diethylamino)benzophenone, methyl 2-benzoylbenzoate, 3,3′-dimethyl-4-methoxybenzophenone, 4-(4-methylphenylthio)-benzophenone, 2,4,6-trimethyl-4′-phenyl-benzophenone or 3-methyl-4′-phenyl-benzophenone; ketal compounds, for example 2,2-dimethoxy-1,2-diphenyl-ethanone; and monomeric or dimeric phenylglyoxylic acid esters, such as methylphenylglyoxylic acid ester, 5,5′-oxo-di(ethyleneoxydicarbonylphenyl) or 1,2-(benzoylcarboxy)ethane.

Other suitable photoinitiators according to this invention, with or without acylphosphine oxide photoinitiators, are for example oxime esters as disclosed in U.S. Pat. No. 6,596,445 or US 2004-0170924-A, the disclosure of which is hereby incorporated by reference. Suitable oxime ester photoinitiators are for example

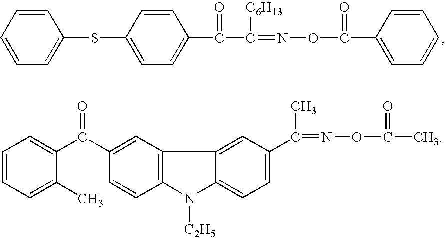

Another class of suitable photoinitiators according to this invention, with or without acylphosphine oxide photoinitiators, are for example phenyl glyoxylates, for example as disclosed in U.S. Pat. No. 6,048,660, the disclosure of which is hereby incorporated by reference. For example phenyl glyoxalates of the formula

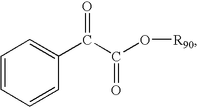

wherein

R₉₀ is C₁-C₄alkyl, in particular methyl or is

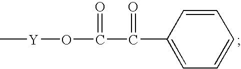

Y is C₁-C₁₂alkylene, cyclohexlyene, C₂-C₄₀alkylene interrupted one or more times by cyclohexylene, O, S, or NR₃₀, and R₃₀ is hydrogen, C₁-C₁₂alkyl or phenyl, preferably Y is CH₂CH₂—O—CH₂CH₂.

The given amount of photoinitiators in the composition refers to both, the photoinitiators (b) and optional photoinitiators (d), in other words, to the sum of all photoinitiators.

The photocured thin films of the invention are for example coatings or adhesives, for example, coatings for metal, plastic, wood, composite materials or glass.

Thin coatings are less than about 10 mils (about 0.25 mm), for example from about 0.1 mils to about 10 mils (about 0.76 mm). The coatings are for example less than about 9 mils (0.23 mm), 8 mils (0.2 mm), 7 mils (0.18 mm), 6 mils (0.15 mm), 5 mils (0.13 mm), 4 mils (0.1 mm), 3 mils (0.075 mm), 2 mils (0.05 mm) or 1 mil (0.025 mm).

Adhesives of the invention are used in, for example laminating, structure or pressure sensitive adhesives, such as for example pressure sensitive hot-melt adhesives.

Said adhesives can be hot melt adhesives as well as waterborne or solvent borne adhesives. In particular suitable are pressure-sensitive adhesives, for example uv-curable hot melt pressure sensitive adhesives. Said adhesives for example comprise at least one rubber component, at least one resin component as tackifier and at least one oil component, for example in the weight ratio 30:50:20. Suitable tackifiers are natural or synthetic resins. The person skilled in the art is aware of suitable corresponding compounds as well as of suitable oil components or rubbers.

To accelerate the photopolymerization it is possible to add amines, for example triethanolamine, N-methyldiethanolamine, ethyl p-dimethylaminobenzoate or Michler's ketone. The action of the amines can be intensified by the addition of aromatic ketones of the benzophenone type. Examples of amines which can be used as oxygen scavengers are substituted N,N-dialkylanilines as described in EP 339841-A. Further accelerators, co initiators and autoxidizers are thiols, thioethers, disulfides and phosphines, as are described, for example, in EP 438123-A and GB 2180358-A.

The photopolymerization can also be accelerated by the addition of photosensitizers, which shift or broaden the spectral sensitivity. These are, in particular, aromatic carbonyl compounds, such as benzophenone derivatives, thioxanthone derivatives, anthraquinone derivatives and 3-acylcoumarin derivatives, and also 3-(aroylmethylene)thiazolines, and also eosine, rhodamine and erythrosine dyes.

The curing procedure can be assisted, in particular, by compositions which are pigmented (for example with titanium dioxide), and also by adding a component which forms free radicals under thermal conditions, for example an azo compound such as 2,2′-azobis(4-methoxy-2,4-dimethylvaleronitrile), a triazene, a diazo sulfide, a pentazadiene or a peroxy compound, such as a hydroperoxide or peroxycarbonate, for example t-butyl hydroperoxide, as described in U.S. Pat. No. 4,753,817.

The novel compositions can also include a photo reducible dye, e.g. as component (d), for example xanthene, benzoxanthene, benzothioxanthene, thiazine, pyronine, porphyrin or acridine dyes, and/or a trihalomethyl compound which can be cleaved by radiation. Similar compositions are described, for example, in U.S. Pat. No. 5,229,253.

The light source used for curing in the instant process can be a known light source commonly used in UV curing such as UV lamps, high intensity visible light sources, lasers, fluorescent lamps, LED arrays etc, provided that the light emitted from the source contains light with wavelengths above 350 nm.

In one particular embodiment of the invention, low intensities of visible or near visible light, i.e., light with wavelengths of 370 or higher or 390 nm or higher is employed.

One embodiment of the invention employs fluorescent lamps which emit light comprising visible light or LED light sources. One particular embodiment employs an LED light source.

The LED light sources according to the invention operate at low heat. For example the LED light sources operate at about 390 nm plus or minus 30 nm, at about 250 mW/cm². The LED light sources operate at low heat, for example below the boiling point (bp) of volatiles in the resin, for example below the by of styrene at atmospheric pressure.

Light emitting diode light sources have been used for example for dental applications. For example as disclosed in US 2002-113217-A, US 2002-115037-A and US 2001-046652-A, CA 2332190, JP 2000-271155-A, U.S. Pat. No. 6,200,134 and U.S. Pat. No. 6,159,005, EP 780104, EP 780103, U.S. Pat. No. 5,316,473 and U.S. Pat. No. 6,007,965. The relevant disclosures of the above Patent applications and Patents are hereby incorporated by reference.

The ethylenically unsaturated polymerizable compounds (a) can contain one or more than one olefinic double bond. They may be low molecular (monomeric) or high molecular (oligomeric or polymeric) compounds. In a particular embodiment, the unsaturated polymerizable compounds comprise unsaturated polyester monomers, oligomers or polymers. Preferably the ethylenically unsaturated polymerizable compounds (a) comprise at least one acrylate monomer, oligomer, prepolymer or resin or at least one unsaturated polyester resin.

Typical examples of monomers containing one double bond are alkyl or hydroxyalkyl acrylates or methacrylates, for example methyl, ethyl, butyl, 2-ethylhexyl and 2-hydroxyethyl acrylate, isobornyl acrylate, and methyl and ethyl methacrylate. Further examples of these monomers are acrylonitrile, acrylamide, methacrylamide, N-substituted (meth)acrylamides, vinyl esters such as vinyl acetate, vinyl ethers such as isobutyl vinyl ether, styrene, alkylstyrenes, halostyrenes, N-vinylpyrrolidone, vinyl chloride and vinylidene chloride.

Examples of monomers containing more than one double bond are ethylene glycol diacrylate, propylene glycol diacrylate, neopentyl glycol diacrylate, hexamethylene glycol diacrylate, bisphenol A diacrylate, 4,4′-bis(2-acryloyloxyethoxy)diphenylpropane, trimethylolpropane triacrylate, pentaerythritol triacrylate and tetraacrylate, pentaerythritol divinyl ether, vinyl acrylate, divinyl benzene, divinyl succinate, diallyl phthalate, triallyl phosphate, triallyl isocyanurate or tris(2-acryloylethyl)isocyanurate. Examples of high molecular weight (oligomeric) polyunsaturated compounds are acrylated epoxy resins, acrylated polyethers, acrylated polyurethanes and acrylated polyesters. Further examples of unsaturated oligomers are unsaturated polyester resins, which are usually prepared from maleic acid, phthalic acid and one or more diols and which have molecular weights of greater than about 500. Unsaturated oligomers of this type are also known as prepolymers.

Typical examples of unsaturated compounds are esters of ethylenically unsaturated carboxylic acids and polyols or polyepoxides, and polymers containing ethylenically unsaturated groups in the chain or in side groups, including unsaturated polyesters, polyamides and polyurethanes and copolymers thereof, polybutadiene and butadiene copolymers, polyisoprene and isoprene copolymers, polymers and copolymers containing (meth)acrylic groups in side-chains, as well as mixtures of one or more than one such polymer.

Illustrative examples of unsaturated carboxylic acids are acrylic acid, methacrylic acid, crotonic acid, itaconic acid, cinnamic acid, unsaturated fatty acids such as linolenic acid or oleic acid.

Suitable polyols are aromatic, aliphatic and cycloaliphatic polyols. Aromatic polyols are typically hydroquinone, 4,4′-dihydroxydiphenyl, 2,2-bis(4-hydroxyphenyl)propane, as well as novolacs and cresols. Polyepoxides include those based on the cited polyols, for instance on the aromatic polyols and epichlorohydrin. Further suitable polyols are polymers and copolymers which contain hydroxyl groups in the polymer chain or in side groups, for example polyvinyl alcohol and copolymers thereof or hydroxyalkyl polymethacrylates or copolymers thereof. Other suitable polyols are oligoesters carrying hydroxyl end groups.

Illustrative examples of aliphatic and cycloaliphatic polyols are alkylenediols containing for example 2 to 12 carbon atoms, including ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of for instance 200 to 1500, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol and sorbitol.

The polyols may be esterified partially or completely with one or with different unsaturated carboxylic acids, in which case the free hydroxyl groups of the partial esters may be modified, for example etherified, or esterified with other carboxylic acids.

Illustrative examples of esters are: Trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentacrylate, dipentaerythritol hexacrylate, tripentaerythritol octacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetramethacrylate, sorbitol pentacrylate, sorbitol hexacrylate, oligoester acrylates and methacrylates, glycerol di- and-triacrylate, 1,4-cyclohexanediacrylate, bisacrylates and bismethacrylates of polyethylene glycol having molecular weights of 200 to 1500, or mixtures thereof. Polyfunctional monomers and oligomers are available for example from UCB CHEMICALS, Smyrna, Ga., and SARTOMER, Exton, Pa.

Suitable ethylenically unsaturated polymerizable compounds are also the amides of identical or different unsaturated carboxylic acids of aromatic, cycloaliphatic and aliphatic polyamines containing for instance 2 to 6, for example 2 to 4, amino groups. Exemplary of such polyamines are ethylenediamine, 1,2- or 1,3-propylenediamine, 1,2-, 1,3-or 1,4-butylenediamine, 1,5-pentylenediamine, 1,6-hexylenediamine, octylenediamine, dodecylenediamine, 1,4-diaminocyclohexane, isophoronediamine, phenylenediamine, bisphenylenediamine, bis(β-aminoethyl)ether, diethylenetriamine, triethylenetetramine, bis((β-aminoethoxy)ethane or bis(β-aminopropoxy)ethane. Other suitable polyamines are polymers and copolymers which may contain additional amino groups in the side-chain and oligoamides containing amino end groups.

Exemplary of such unsaturated amides are: methylenebisacrylamide, 1,6-hexamethylene-bisacrylamide, diethylenetriaminetrismethacrylamide, bis(methacrylamidopropoxy)ethane, β-methacrylamidoethylmethacrylate, N-[(β-hydroxyethoxy)ethyl]acrylamide.

Suitable unsaturated polyesters and polyamides are derived typically from maleic acid and diols or diamines. Maleic acid can be partially replaced by other dicarboxylic acids such as fumaric acid, itaconic acid, citraconic acid, mesaconic acid or chloromaleic acid. To control the reactivity of the polyester and to influence the crosslinking density and hence the product properties, it is possible to use in addition to the unsaturated dicarboxylic acids different amounts of saturated dicarboxylic acids such as phthalic acid, isophthalic acid, terephthalic acid, tetrahydrophthalic acid, succinic acid or adipic acid. The unsaturated polyesters can be used together with ethylenically unsaturated co monomers such as styrene. The polyesters and polyamides can also be derived from dicarboxylic acids and ethylenically unsaturated diols or diamines, especially from those with long chains containing typically from 6 to 20 carbon atoms. Polyurethanes are typically those derived from saturated or unsaturated diisocyanates and unsaturated and saturated diols.

Suitable polyester acrylates or acrylated polyesters are obtained by reacting oligomers, typically epoxides, urethanes, polyethers or polyesters, with acrylates such as hydroxyethyl acrylate or hydroxypropyl acrylate.

Polybutadiene and polyisoprene and copolymers thereof are known. Suitable co monomers include olefins such as ethylene, propene, butene, hexene, (meth)acrylates, acrylonitrile, styrene or vinyl chloride. Polymers containing (meth)acrylate groups in the side-chain are also known. They may typically be reaction products of epoxy resins based on novolak with (meth)acrylic acid, homo- or copolymers of polyvinyl alcohol or their hydroxyalkyl derivatives which are esterified with (meth)acrylic acid or homo- and copolymers of (meth)acrylates which are esterified with hydroxyalkyl(meth)acrylates.

Monomers are for instance alkyl- or hydroxyalkyl acrylates or methacrylates, styrene, ethylene glycol diacrylate, propylene glycol diacrylate, neopentyl glycol diacrylate, hexamethylene glycol diacrylate or bisphenol A diacrylate, 4,4′-bis(2-acryloyloxyethoxy)diphenylpropane, trimethylolpropane triacrylate, pentaerythritol triacrylate or tetraacrylate, for instance acrylates, styrene, hexamethylene glycol or bisphenol A diacrylate, 4,4′-bis(2-acryloyloxyethoxy)-diphenylpropane or trimethylolpropane triacrylate.

Oligomeric polyunsaturated compounds are for instance polyester acrylates or unsaturated polyester resins which are prepared from maleic acid, fumaric acid, phthalic acid and one or more than one diol, and which typically have molecular weights from about 500 to 3000.

Unsaturated carboxylic acids are for example acrylic acid and methacrylic acid.

The photopolymerizable compounds are used by themselves or in any desired mixtures. It is suitable to use mixtures of polyol(meth)acrylates.

Binders may also be added to the unsaturated photopolymerizable compounds. The addition of binders is particularly useful if the photopolymerizable compounds are liquid or viscous substances. The amount of binder may be from 5-95, for example 10-90, for instance 40-90, percent by weight, based on the entire composition. The choice of binder will depend on the field of use and the desired properties therefore, such as the ability of the compositions to be developed in aqueous and organic solvent systems, adhesion to substrates and susceptibility to oxygen.

Suitable binders are typically polymers having a molecular weight of about 5,000 to 2,000,000, for instance 10,000 to 1,000,000. Illustrative examples are: homo- and copolymers of acrylates and methacrylates, including copolymers of methyl methacrylate/ethyl acrylate/methacrylic acid, poly(alkylmethacrylates), poly(alkylacrylates); cellulose esters and ethers such as cellulose acetate, cellulose acetobutyrate, methyl cellulose, ethyl cellulose; polyvinyl butyral, polyvinyl formal, cyclized rubber, polyethers such as polyethylene oxide, polypropylene oxide, polytetrahydrofuran; polystyrene, polycarbonate, polyurethane, chlorinated polyolefins, polyvinyl chloride, copolymers of vinyl chloride/vinylidene chloride, copolymers of vinylidene chloride with acrylonitrile, methyl methacrylate and vinyl acetate, polyvinyl acetate, copoly(ethylene/vinyl acetate), polymers such as polycaprolactam and poly(hexamethylene adipamide), polyesters such as poly(ethylene glycol terephthalate) and poly(hexamethylene glycol succinate).

The unsaturated compounds can also be used in admixture with non-photopolymerizable film-forming components. These components may be physically drying polymers or solutions thereof in organic solvents, for example nitrocellulose or cellulose acetobutyrate. The photopolymerizable unsaturated monomers may be a component of a free radical-ionic curable blend, such as a free radical-cationic curable blend. Also of importance are systems that undergo both thermal and photo-induced curing cycles, such as are used in powder coatings, laminates, certain adhesives and conformal coatings.

Mixtures of a prepolymer with polyunsaturated monomers which additionally contain a further unsaturated monomer are suitable. The prepolymer in this instance primarily determines the properties of the film and, by varying said prepolymer, the skilled person can influence the properties of the cured film. The polyunsaturated monomer acts as crosslinking agent that renders the film insoluble. The mono-unsaturated monomer acts as reactive diluent with the aid of which the viscosity is lowered without having to use a solvent. Moreover, properties of the cured composition such as curing rate, crosslinking density and surface properties are dependent on the choice of monomer.

Unsaturated polyester resins are usually used in two-component systems, together with a mono-unsaturated monomer, for example with styrene.

A suitable process is that wherein the ethylenically unsaturated polymerizable compounds are a mixture of at least one oligomeric compound and at least one monomer.

An interesting process is that wherein the ethylenically unsaturated polymerizable compounds are a mixture of 1) unsaturated polyesters, especially those that are prepared from maleic acid, fumaric acid and/or phthalic acid and one or more than one diol, and which have molecular weights of 500 to 3,000, and 2) acrylates, methacrylates or styrene or combinations thereof.

In one embodiment of the invention the ethylenically unsaturated polymerizable compounds are a mixture of 1) unsaturated polyesters or a mixture of 2) acrylates or methacrylates or combinations thereof.

The photopolymerizable mixtures may contain various additives in addition to the photoinitiator. Examples of these are thermal inhibitors, which are intended to prevent premature polymerization, examples being hydroquinone, hydroquinone derivatives, p-methoxyphenol, beta-naphthol or sterically hindered phenols, such as 2,6-di(tert-butyl)-p-cresol. The shelf life in the dark can be increased, for example, by using copper compounds, such as copper naphthenate, copper stearate or copper octoate, phosphorus compounds, for example triphenylphosphine, tributylphosphine, triethyl phosphite, triphenyl phosphite or tribenzyl phosphite, quaternary ammonium compounds, such as tetramethylammonium chloride or trimethylbenzylammonium chloride, or hydroxylamine derivatives, such as N-diethylhydroxylamine. In order to keep out atmospheric oxygen during the polymerization, paraffin or similar waxlike substances can be added; these migrate to the surface on commencement of the polymerization because of their low solubility in the polymer, and form a transparent surface layer which prevents the ingress of air. It is likewise possible to apply an oxygen barrier layer. Light stabilizers which can be added are UV absorbers, for example well known commercial UV absorbers of the hydroxyphenylbenzotriazole, hydroxyphenylbenzophenone, oxalamide or hydroxyphenyl-s-triazine type. It is possible to use individual such compounds or mixtures thereof, with or without the use of sterically hindered amine light stabilizers (HALS). Sterically hindered amines are for example based on 2,2,6,6-tetramethylpiperidine.

UV Absorbers and Sterically Hindered Amines are for Example:

2-(2-Hydroxyphenyl)-2H-benzotriazoles, for example known commercial hydroxyphenyl-2H-benzotriazoles and benzotriazoles as disclosed in U.S. Pat. No. 3,004,896; U.S. Pat. No. 3,055,896; U.S. Pat. No. 3,072,585; U.S. Pat. No. 3,074,910; U.S. Pat. No. 3,189,615; U.S. Pat. No. 3,218,332; U.S. Pat. No. 3,230,194; U.S. Pat. No. 4,127,586; U.S. Pat. No. 4,226,763; U.S. Pat. No. 4,275,004; U.S. Pat. No. 4,278,589; U.S. Pat. No. 4,315,848; U.S. Pat. No. 4,347,180; U.S. Pat. No. 4,383,863; U.S. Pat. No. 4,675,352; U.S. Pat. No. 4,681,905, U.S. Pat. No. 4,853,471; U.S. Pat. No. 5,268,450; U.S. Pat. No. 5,278,314; U.S. Pat. No. 5,280,124; U.S. Pat. No. 5,319,091; U.S. Pat. No. 5,410,071; U.S. Pat. No. 5,436,349; U.S. Pat. No. 5,516,914; U.S. Pat. No. 5,554,760; U.S. Pat. No. 5,563,242; U.S. Pat. No. 5,574,166; U.S. Pat. No. 5,607,987, U.S. Pat. No. 5,977,219 and U.S. Pat. No. 6,166,218 such as 2-(2-hydroxy-5-methylphenyl)-2H-benzotriazole, 2-(3,5-di-t-butyl-2-hydroxyphenyl)-2H-benzotriazole, 2-(2-hydroxy-5-t-butylphenyl)-2H-benzotriazole, 2-(2-hydroxy-5-t-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotriazole, 2-(2-hydroxy-4-octyloxyphenyl)-2H-benzotriazole, 2-(3,5-di-t-amyl-2-hydroxyphenyl)-2H-benzotriazole, 2-(3,5-bis-α-cumyl-2-hydroxyphenyl)-2H-benzotriazole, 2-(3-t-butyl-2-hydroxy-5-(2-(ω-hydroxy-octa-(ethyleneoxy)carbonyl-ethyl)-, phenyl)-2H-benzotriazole, 2-(3-dodecyl-2-hydroxy-5-methylphenyl)-2H-benzotriazole, 2-(3-t-butyl-2-hydroxy-5-(2-octyloxycarbonyl)ethylphenyl)-2H-benzotriazole, dodecylated 2-(2-hydroxy-5-methylphenyl)-2H-benzotriazole, 2-(3-t-butyl-2-hydroxy-5-(2-octyloxycarbonylethyl)-phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-t-butyl-2-hydroxy-5-(2-methoxycarbonylethylphenyl)-5-chloro-2H-benzotriazole, 2-(3-t-butyl-2-hydroxy-5-(2-methoxycarbonylethyl)phenyl)-2H-benzotriazole, 2-(3-t-butyl-5-(2-(2-ethylhexyloxy)carbonylethyl)-2-hydroxyphenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl-(6-2H-benzotriazol-2-yl)phenol), 2-(2-hydroxy-3-\tilde{α}cumyl-5-t-octyl-phenyl)-2H-benzotriazole, 2-(2-hydroxy-3-t-octyl-5-\tilde{α}cumylphenyl)-2H-benzotriazole, 5-fluoro-2-(2-hydroxy-3,5-di-α-cumylphenyl)-2H-benzotriazole, 5-chloro-2-(2-hydroxy-3,5-di-α-cumyl-phenyl)-2H-benzotriazole, 5-chloro-2-(2-hydroxy-3-α-cumyl-5-t-octylphenyl)-2H-benzotriazole, 2-(3-t-butyl-2-hydroxy-5-(2-isooctyloxycarbonylethyl)phenyl)-5-chloro-2H-benzotriazole, 5-trifluoromethyl-2-(2-hydroxy-3-α-cumyl-5-t-octylphenyl)-2H-benzotriazole, 5-trifluoromethyl-2-(2-hydroxy-5-t-octylphenyl)-2H-benzotriazole, 5-trifluoromethyl-2-(2-hydroxy-3,5-di-t-octylphenyl)-2H-benzotriazole, methyl 3-(5-trifluoromethyl-2H-benzotriazol-2-yl)-5-t-butyl-4-hydroxyhydrocinnamate, 5-butylsulfonyl-2-(2-hydroxy-3-α-cumyl-5-t-octylphenyl)-2H-benzotriazole, 5-trifluoromethyl-2-(2-hydroxy-3-\tilde{α}cumyl-5-t-butylphenyl)-2H-benzotriazole, 5-trifluoromethyl-2-(2-hydroxy-3,5-di-t-butylphenyl)-2H-benzotriazole, 5-trifluoromethyl-2-(2-hydroxy-3,5-di-α-cumylphenyl)-2H-benzotriazole, 5-butylsulfonyl-2-(2-hydroxy-3,5-di-t-butylphenyl)-2H-benzotriazole and 5-phenylsulfonyl-2-(2-hydroxy-3,5-di-t-butylphenyl)-2H-benzotriazole.

2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

Esters of substituted and unsubstituted benzoic acids, as for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

Acrylates and malonates, for example, α-cyano-β,β-diphenylacrylic acid ethyl ester or isooctyl ester, α-carbomethoxy-cinnamic acid methyl ester, α-cyano-β-methyl-p-methoxy-cinnamic acid methyl ester or butyl ester, α-carbomethoxy-p-methoxy-cinnamic acid methyl ester, N-(β-carbomethoxy-β-cyanovinyl)-2-methyl-indoline, dimethyl p-methoxybenzylidenemalonate (CAS #7443-25-6), and di-(1,2,2,6,6-pentamethylpiperidin-4-yl) p-methoxybenzylidene-malonate (CAS #147783-69-5).

Sterically hindered amine stabilizers, for example 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,-6,6-tetramethyl-4-piperidyl)nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decan-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis-(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS #136504-96-6); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro[4,5]-decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine, poly[methylpropyl-3-oxy-4-(2,2,6,6-tetramethyl-4-piperidyl)]siloxane, reaction product of maleic acid anhydride-α-olefin-copolymer with 2,2,6,6-tetramethyl-4-amino-piperidine or 1,2,2,6,6-pentamethyl-4-aminopiperidine.

The sterically hindered amine may also be one of the compounds described in U.S. Pat. No. 5,980,783. The sterically hindered amine may also be one of the compounds described in U.S. Pat. No. 6,046,304 and U.S. Pat. No. 6,297,299, the disclosures of which are hereby incorporated by reference.

Sterically hindered amines substituted on the N-atom by a hydroxy-substituted alkoxy group, for example compounds such as 1-(2-hydroxy-2-methylpropoxy)-4-octadecanoyloxy-2,2,6,6-tetramethylpiperidine, 1-(2-hydroxy-2-methylpropoxy)-4-hexadecanoyloxy-2,2,6,6-tetramethylpiperidine, the reaction product of 1-oxyl-4-hydroxy-2,2,6,6-tetramethylpiperidine with a carbon radical from t-amylalcohol, 1-(2-hydroxy-2-methylpropoxy)-4-hydroxy-2,2,6,6-tetramethylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl)sebacate, bis(1-(2-hydroxy-2-methylpropoxy)-2,2,6,6-tetramethylpiperidin-4-yl)adipate, bis(1-(2-hydroxy-2-methylpropoxy)-2,2,6,6-tetramethylpiperidin-4-yl)succinate, bis(1-(2-hydroxy-2-methylpropoxy)-2,2,6,6-tetramethylpiperidin-4-yl)glutarate and 2,4-bis{N-[1-(2-hydroxy-2-methylpropoxy)-2,2,6,6-tetramethylpiperidin-4-yl]-N-butylamino}-6-(2-hydroxyethylamino)-s-triazine.

Oxamides, for example 4,4′-dioctyloxyoxanilide, 2,2′-diethoxyoxanilide, 2,2′-dioctyloxy-5,5′-ditert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

Tris-aryl-o-hydroxyphenyl-s-triazines, for example known commercial tris-aryl-o-hydroxyphenyl-s-triazines and triazines as disclosed in U.S. Pat. No. 3,843,371; U.S. Pat. No. 4,619,956; U.S. Pat. No. 4,740,542; U.S. Pat. No. 5,096,489; U.S. Pat. No. 5,106,891; U.S. Pat. No. 5,298,067; U.S. Pat. No. 5,300,414; U.S. Pat. No. 5,354,794; U.S. Pat. No. 5,461,151; U.S. Pat. No. 5,476,937; U.S. Pat. No. 5,489,503; U.S. Pat. No. 5,543,518; U.S. Pat. No. 5,556,973; U.S. Pat. No. 5,597,854; U.S. Pat. No. 5,681,955; U.S. Pat. No. 5,726,309; U.S. Pat. No. 5,736,597; U.S. Pat. No. 5,942,626; U.S. Pat. No. 5,959,008; U.S. Pat. No. 5,998,116; U.S. Pat. No. 6,013,704; U.S. Pat. No. 6,060,543; U.S. Pat. No. 6,187,919; U.S. Pat. No. 6,242,598 and U.S. Pat. No. 6,468,958, for example 4,6-bis-(2,4-dimethylphenyl)-2-(2-hydroxy-4-octyloxyphenyl)-s-triazine, 4,6-bis-(2,4-dimethylphenyl)-2-(2,4-dihydroxyphenyl)-s-triazine, 2,4-bis(2,4-dihydroxyphenyl)-6-(4-chlorophenyl)-s-triazine, 2,4-bis[2-hydroxy-4-(2-hydroxyethoxy)phenyl]-6-(4-chlorophenyl)-s-triazine, 2,4-bis[2-hydroxy-4-(2-hydroxy-4-(2-hydroxyethoxy)phenyl]-6-(2,4-dimethylphenyl)-s-triazine, 2,4-bis[2-hydroxy-4-(2-hydroxy-ethoxy)phenyl]-6-(4-bromophenyl)-s-triazine, 2,4-bis[2-hydroxy-4-(2-acetoxyethoxy)phenyl]-6-(4-chlorophenyl)-s-triazine, 2,4-bis(2,4-dihydroxyphenyl)-6-(2,4-dimethylphenyl)-s-triazine, 2,4-bis(4-biphenylyl)-6-(2-hydroxy-4-octyloxycarbonylethylideneoxyphenyl)-s-triazine, 2-phenyl-4-[2-hydroxy-4-(3-sec-butyloxy-2-hydroxypropyloxy)phenyl]-6-[2-hydroxy-4-(3-secamyloxy-2-hydroxypropyloxy)phenyl]-s-triazine, 2,4-bis(2,4-dimethylphenyl)-6-[2-hydroxy-4-(3-benzyloxy-2-hydroxypropyloxy)phenyl]-s-triazine, 2,4-bis(2-hydroxy-4-n-butyloxyphenyl)-6-(2,4-di-n-butyloxyphenyl)-s-triazine, 2,4-bis(2,4-dimethylphenyl)-6-[2-hydroxy-4-(3-nonyloxy*-2-hydroxypropyloxy)-5-α-cumylphenyl]-s-triazine (* denotes a mixture of octyloxy, nonyloxy and decyloxy groups), methylenebis-{2,4-bis(2,4-dimethylphenyl)-6-[2-hydroxy-4-(3-butyloxy-2-hydroxypropoxy)phenyl]-s-triazine}, methylene bridged dimer mixture bridged in the 3:5′, 5:5′ and 3:3′ positions in a 5:4:1 ratio, 2,4,6-tris(2-hydroxy-4-isooctyloxycarbonyl-isopropylideneoxyphenyl)-s-triazine, 2,4-bis(2,4-dimethylphenyl)-6-(2-hydroxy-4-hexyloxy-5-α-cumylphenyl)-s-triazine, 2-(2,4,6-trimethylphenyl)-4,6-bis[2-hydroxy-4-(3-butyloxy-2-hydroxypropyloxy)phenyl]-s-triazine, 2,4,6-tris[2-hydroxy-4-(3-sec-butyloxy-2-hydroxypropyloxy)phenyl]-s-triazine, mixture of 4,6-bis-(2,4-dimethylphenyl)-2-(2-hydroxy-4-(3-dodecyloxy-2-hydroxypropoxy)-phenyl)-s-triazine and 4,6-bis-(2,4-dimethylphenyl)-2-(2-hydroxy-4-(3-tridecyloxy-2-hydroxypropoxy)-phenyl)-s-triazine, 4,6-bis-(2,4-dimethylphenyl)-2-(2-hydroxy-4-(3-(2-ethylhexyloxy)-2-hydroxypropoxy)-phenyl)-s-triazine and 4,6-diphenyl-2-(4-hexyloxy-2-hydroxyphenyl)-s-triazine.

Other conventional additives are—depending on the intended application—fluorescent whiteners, fillers, pigments, dyes, wetting agents or leveling assistants. Coatings can also contain glass microbeads or powdered glass fibers, as described in U.S. Pat. No. 5,013,768, for example.

In one embodiment of the invention also is process as described above, wherein the composition to be irradiated comprises in addition to at least one ethylenically unsaturated compound (a), at least one photoinitiator (b) and at least one acrylated siloxanes (c) at least one additional component (d) selected from further photoinitiators, co-initiators, dyes, pigments and film-forming binders based on thermoplastic or thermocurable resins.

The additive composition, i.e., photoinitiator and acrylated siloxane, are added to the formulation comprising the ethylenically unsaturated compounds using standard methods. For example, the components of the additive composition are added singly or together to the formulation by stirring, blending, compounding, dry mixing, dissolution, suspension, milling etc. The components of the additive composition may be added neat or as part of a mixture with, for example solvents and/or other additives, monomers, resins crosslinkers etc.

When the thin film of the invention is a coating or adhesive, the mixture comprising the ethylenically unsaturated polymerizable compounds, the photoinitiator and the acrylated siloxane is applied to a substrate using any known application techniques prior to irradiation.

Coating of the substrates can be carried out by applying to the substrate a liquid composition, a solution or a suspension. The choice of solvents and the concentration depend principally on the type of composition and on the coating technique. The solvent should be inert, i.e. it should not undergo a chemical reaction with the components and should be able to be removed again, after coating, in the course of drying. Examples of suitable solvents are ketones, ethers and esters, such as methyl ethyl ketone, isobutyl methyl ketone, cyclopentanone, cyclohexanone, N-methylpyrrolidone, dioxane, tetrahydrofuran, 2-methoxyethanol, 2-ethoxryethanol, 1-methoxy-2-propanol, 1,2-dimethoxyethane, ethyl acetate, n-butyl acetate and ethyl 3-ethoxypropionate. The solution or suspension is applied uniformly to a substrate by means of known coating techniques, for example by spin coating, dip coating, knife coating, curtain coating, brushing, spraying, especially by electrostatic spraying, and reverse-roll coating. It is also possible to apply the photosensitive layer to a temporary, flexible support and then to coat the final substrate, for example a copper-clad circuit board, by transferring the layer via lamination.

The coating composition may also be a solid, as in a powder coating and is applied in this instance using standard powder coating application techniques.

### EXAMPLES

The invention is further described in the following Examples. Unless otherwise indicated, parts and percentages are by weight, based on the weight of the entire formulation.

### Example 1

In the following formulations, the following photoinitiators are employed:
PI-1 bis(2,4,6-trimethylbenzoyl)-phenyl phosphine oxide
PI-2 2-Benzyl-2-(dimethylamino)-1-[4-(4-morpholinyl)phenyl]-1-butanone

As the acrylated siloxane component (c) is used:
SI-1 a polyisloxane modified polymer with unsaturated terminal groups in butylacetate/isobutanol as solvent (active ingredients 69-71%), EFKA®3883, provided by CIBA Inc.

UPES resin (INTERPLASTIC SIL 83 BA 2310 resin) coating formulations containing PI-1 or PI-2 and other additives as shown in the table below is prepared and applied to electrocoated steel panels using a drawndown bar to produce wet coatings approximately 10 mil (i.e., ˜0.25 mm) thick. The coatings are then cured using a Clearstone Tech LED array at 395 nm, Distance: 2 inch (5.08 cm), Power: 100%. The cured films are approximately 5 mil (i.e., ˜0.13 mm) thick and the level of dry cure reported in the table. The most fully cured, non-tacky system is obtained using 2% PI 1 and 1% SI 1 by weight and cured for 8 minutes.

| | | Cure time | |
|---|---|---|---|
| PI system | Other additives | [min] | Observations |
| 4% PI-6 | — | 4 | Little sticky |
| 4% PI-1 | 0.5% SI-1 | 4 | Almost dry |
| 4% PI-1 | 0.5% SI-1 | 4 | Almost dry |
| 4% PI-1 | 1% active silica | 4 | Little sticky |
| 4% PI-1 | 1% SI-1 | 4 | Dry |
| 4% PI-1 | 1% SI-1 | 4 | Dry |
| 2% PI-1 | 1% SI-1 | 4 | Not sticky |
| 2% PI-1 | 1% SI-1 | 4 | Not sticky |
| 2% PI-1 | 1% SI-1 | 4 | Dry |
| 2% PI-1 | 1% SI-1 | 8 | Hard surface. Dry* |
| 2% PI-1 | 1% SI-1 | 8 | Hard surface. Dry* |
| 1% PI-1 | — | 4 | Sticky |
| 1% PI-1 | — | 4 | Sticky |
| 1% PI-1 | 1% SI-1 | 4 | Dry |
| 1% PI-1 | 1% SI-1 | 8 | Dry |
| 1% PI-1 | 2% SI-1 | 4 | Dry |
| 1% PI-1 | 2% SI-1 | 8 | Dry |
| 0.5% PI-1 | 2% SI-1 | 4 | Not sticky |
| 0.5% PI-1 | 2% SI-1 | 8 | Not sticky |
| 0.5% PI-1 | — | 4 | Sticky |

### Example 2

A coating formulation consisting of an unsaturated polyester oligomer with 35% by weight of a styrene diluent added to control viscosity, 15% by weight rutile TiO₂, 2% by weight of the photoinitiator, bis(2,4,6-trimethylbenzoyl)phenylphosphine, and 1% SI-1 as acrylated siloxane. The mixture is drawn down on a glass substrate and cured using a LED source with a narrow output between 380 and 400 nm, CW power of 250 mW/cm² at a Lamp distance of about 12 mm above the sample to provide a cured tack free glassy solid film with a thickness of about 2 mils (=0.05 mm).

### Example 3

Thin acrylate coating formulations are prepared (1 mil i.e., 0.0254 mm) with difunctional epoxy acrylate and bis(2,4,6-trimethylbenzoyl)phenylphosphine as photoinitiator at 2% by weight and 1% SI-1 as acrylated siloxane, based on the weight of the entire formulation. Excellent cure is achieved for each formulation with an LED light source centered at 390 nm at 240 mW/cm².

The photoinitiator in the examples 2 and 3 is replaced with a mixture of bis(2,4,6-trimethylbenzoyl)phenylphosphine oxide and 2,4,6,-trimethylbenzoylethoxyphenylphosphine oxide (CAS #84434-11-7) in a weight:weight ratio of about 1:9; or a mixture of bis(2,4,6-trimethylbenzoyl)phenylphosphine oxide, 2,4,6,-trimethylbenzoylethoxyphenylphosphine oxide and 2-hydroxy-2-methyl-1-phenyl-1-propanone in a weight ratio of about 3.5:1.0:15.5; or a mixture of bis(2,4,6-trimethylbenzoyl)phenylphosphine oxide and 2-hydroxy-2-methyl-1-phenyl-1-propanone in a weight ratio of about 1:4, with excellent results.

What is claimed:

1. A process for curing compositions comprising ethylenically unsaturated polymerizable compounds to prepare tack free thin films of from about 0.1 mil to about 10 mil (i.e., 0.002 mm to 0.254 mm), which process comprises
preparing a composition comprising
(a) ethylenically unsaturated polymerizable compounds,
(b) from 0.1 weight percent to 4 weight percent, based on the weight of the cured film solids, of at least one photoinitiator,
(c) from 0.5 weight percent to 3 weight percent, based on the weight of the cured film solids, of at least one acrylated siloxane,
and
irradiating the composition so obtained with light comprising wavelengths of from about 350 nm to about 600 nm.

2. A process according to claim 1, wherein the photoinitiator (b) comprises a photoinitiator which is active at wavelengths of light greater than 390 nm.

3. A process according to claim 1, wherein the photoinitiator (b) comprises a photoinitiator selected from monoacylphosphine oxides, bisacylphosphine oxides, red-shifted phenylglyoxylates, red shifted benzophenone compounds, isopropylthioxanthone compounds and alpha amino ketones.

4. A process according to claim 3, wherein the photoinitiator (b) comprises a photoinitiator selected from monoacylphosphine oxides and bisacylphosphine oxides.

5. A process according to claim 1, wherein the composition is irradiated with light comprising light with wavelengths of 375 nm to 500 nm, in particular from 390 nm to 450 nm.

6. A process according to claim 1, wherein the composition is irradiated with light comprising light with wavelengths of from 390 nm to 450 nm.

7. A process according to claim 1, wherein the composition is irradiated with light from a light emitting diode.

8. A process according to claim 3, wherein the photoinitiator (b) is a mixture of photoinitiators comprising at least one monoacylphosphine oxide photoinitiator and/or at least one bisacylphosphine photoinitiator.

9. A process according to claim 3, wherein the photoinitiator (b) is a mixture of photoinitiators comprising at least one monoacylphosphine oxide and/or at least one bisacylphosphine oxide photoinitiator and at least one α-hydroxyketone photoinitiator.

10. A process according to claim 1, wherein the photoinitiator (b) and the acrylated siloxanes (c) are present in ratios of 1:9 to ratios of 9:1.

11. A process according to claim 1, wherein the photoinitiator (b) comprises (i) a monoacylphosphine oxide or (ii) a bisacylphosphine oxide or (iii) a mixture of photoinitiators containing at least one monoacylphosphine oxide or bisacylphosphine oxide, and the at least one acrylated siloxane (c) is a mono-acyrlated siloxane, and the ratio of the photoinitiator (b) and the acrylated siloxane (c) is of from 3:1 to 1:1.

12. A process according to claim 1, wherein the ethylenically unsaturated polymerizable compounds (a) comprise at least one acrylate monomer, oligomer, prepolymer or resin or at least one unsaturated polyester resin.

13. A process according to claim 1, wherein the composition to be irradiated comprises in addition to at least one ethylenically unsaturated compound (a), at least one photoinitiator (b) and at least one acrylated siloxanes (c), at least one additional component (d) selected from further photoinitiators, co-initiators, dyes, pigments and film-forming binders based on thermoplastic or thermocurable resins.

14. A process according to claim 4, wherein the bisacylphosphine oxide photoinitiator is of the formula I 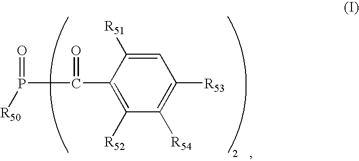
wherein
R₅₀ is C₁-C₁₂ alkyl, cyclohexyl or phenyl which is unsubstituted or is substituted by 1 to 4 halogen, C₁-C₈ alkyl SR₁₀ or N(R₁₁)(R₁₂);
R₁₀, R₁₁ and R₁₂ are each independently of the others hydrogen, C₁-C₂₄alkyl, C₂-C₂₄alkenyl, C₃-C₈cycloalkyl, phenyl, benzyl, or C₂-C₂₀alkyl which is interrupted one or more times by nonconsecutive O atoms and which is unsubstituted or substituted by OH and/or SH; or
R₁₁ and R₁₂ together with the N atom to which they are bonded form a 5- or 6-membered ring, which may also contain O or S atoms or NR₁₃;
R₁₃ is hydrogen, phenyl, C₁-C₁₂alkoxy, C₁-C₁₂alkyl, or C₂-C₁₂alkyl which is interrupted one or more times by O or S and which is unsubstituted or substituted by OH and/or SH;
R₅₁ and R₅₂ are each independently of the other C₁-C₈ alkyl or C₁-C₈alkoxy;
R₅₃ is hydrogen or C₁-C₈ alkyl; and
R₅₄ is hydrogen or methyl.

15. A process according to claim 4 wherein the monoacylphosphine oxide photoinitiator of the formula II 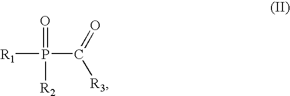
wherein
R₁ and R₂ independently of one another are C₁-C₁₂alkyl, benzyl, phenyl which is unsubstituted or substituted from one to four times by halogen, C₁-C₈alkyl and/or C₁-C₈alkoxy, or are cyclohexyl; or
R₁ is —OR₄;
R₃ is phenyl which is unsubstituted or substituted from one to four times by C₁-C₈alkyl, C₁-C₈alkoxy, C₁-C₈alkylthio and/or halogen; and
R₄ is C₁-C₈alkyl, phenyl or benzyl.

16. A process according to claim 7 wherein the output of the light emitting diode source is centered at 390 nm plus or minus 30 nm.
